(19) United States
(12) Patent Application Publication
(10) Pub. No.: US 2012/0177928 A1
(43) Pub. Date: Jul. 12, 2012

(54) HYDROPHILIC AND SELF CLEANING UV NANO-EPOXY/ACRYLATE CATIONIC HYBRID COATING COMPOSITIONS FOR TRANSPARENT POLYMERIC MATERIALS, METHODS FOR FORMING COATED TRANSPARENT POLYMERIC MATERIALS USING SUCH COATING COMPOSITIONS, AND COATED TRANSPARENT POLYMERIC MATERIALS

(75) Inventors: Xiaorong You, Shrewsbury, MA (US); Yuandong Gu, Plymouth, MN (US)

(73) Assignee: HONEYWELL INTERNATIONAL INC., Morristown, NJ (US)

(21) Appl. No.: 13/426,024

(22) Filed: Mar. 21, 2012

Related U.S. Application Data
(63) Continuation-in-part of application No. 13/179,739, filed on Jul. 11, 2011.
(60) Provisional application No. 61/374,028, filed on Aug. 16, 2010.

(51) Int. Cl. B32B 27/38; C08K 3/10; B05D 5/06; C08F 2/48; C09D 163/10; B32B 27/36; B82Y 30/00

(52) U.S. Cl. 428/412; 523/457; 522/83; 522/81; 428/413; 427/164; 427/508; 977/773

(57) ABSTRACT

Hydrophilic and self cleaning UV nano-epoxy/acrylate cationic hybrid coating composition, methods for coating transparent polymeric materials, and coated transparent polymeric materials are provided herein. In one example, a coating composition for a transparent polymeric material comprises a cationically polymerizable compound, a radically polymerizable compound, a surfactant with both hydrophilic and hydrophobic segments, and a nano-particular filler. The cationically polymerizable compound comprises at least one epoxy group. The radically polymerizable compound comprises at least one (meth)acrylate group and the nano-sized particulate filler comprises TiO₂, and SiO₂ and/or Al₂O₃.

### CROSS-REFERENCE TO RELATED APPLICATIONS

This application is a continuation-in-part (CIP) application of U.S. patent application Ser. No. 13/179,739, filed Jul. 11, 2011, which claims priority to U.S. Provisional Patent Application No. 61/374,028, filed Aug. 16, 2010, which are all hereby incorporated in their entirety by reference.

### TECHNICAL FIELD

The present invention relates generally to coating compositions for transparent polymeric materials, methods for forming coated transparent polymeric materials, and coated transparent polymeric materials, and more particularly relates to hydrophilic and self cleaning UV nano-epoxy/acrylate cationic hybrid coating compositions that impart long-lasting anti-fog performance for transparent polymeric materials, methods for forming coated transparent polymeric materials using such coating compositions, and coated transparent polymeric materials with long-lasting anti-fog performance.

### BACKGROUND

Transparent polymeric materials are used for a variety of products through which light is transmitted for viewing an image. The transparent polymeric material typically has a first surface and a second surface. One surface can be curved relative to the other to change the direction of light to the eye, such as in an ophthalmic lens of eyeglasses, or alternatively, the surfaces can be parallel, such as in a television screen or a face shield of a protective helmet. Common lens forming materials include CR-39 (diethyleneglycol bisallyl carbonate), bisphenol A polycarbonate (PC), and poly(methylmethacrylate) (PMMA). These lens forming materials are lighter and more shatter resistant than traditional glass and offer excellent transparency and low haze. Despite the above noted benefits, some serious drawbacks to transparent polymeric materials include their susceptibility to fogging, scratching and/or abrasion.

Transparent polymeric materials become fogged when tiny water droplets condense on the surface and cause light to scatter, rendering the surface translucent. Fogging typically occurs when a cold surface suddenly comes in contact with warm, moist air. In some cases, fogging can be a dangerous condition, for example, when the fogged material is an ophthalmic lens affecting a user's vision. Additionally, transparent polymeric materials are much softer than glass and can be easily scratched under normal actions such as cleaning, wiping off dust, and normal handling while in use. Over time, scratches and abrasions on the surface can also obscure the user's vision.

Consequently, such transparent polymeric surfaces are often treated with one or more coatings to provide anti-fog performance, and scratch and/or abrasion resistance. Lens coatings can be applied in different ways, such as, for example, using a dip coating process or a spin coating process. Multiple coatings may also be necessary to obtain other desirable properties such as a mirror coating, and stain and smudge resistance.

In this regard, much research has been devoted to providing coatings for transparent polymeric materials to improve their anti-fog performance, and scratch and/or abrasion resistance. State of the art anti-fog (AF) technologies typically include two approaches to maintain surface transparency after moisture condensation. One approach is to treat a surface by applying a completely hydrophilic coating to absorb all of the water molecules in the coating's interior; or alternatively, another approach is to embed hydrophilic surfactants within an otherwise hydrophobic coating to reduce the water contact angle and to spread condensed moisture from scattered and scattering droplets into a flat film (sheeting), thereby minimizing the transmission loss. Each of these approaches has its own limitations and shortcomings.

Current water absorbing AF coating systems are normally made from crosslinked or non-crosslinked hydrophilic polymers (e.g. hydrophilic acrylic polymers or copolymers, crosslonked polyvinyl alcohol, and hydrophilic polyurethane). Water molecules can easily diffuse into this hydrophilic coating layer, thus preventing moisture condensation on the substrate surface. It is fairly easy to make, but the absorption capacity is limited by the thickness of the coating. In addition, the slow kinetics of absorption by diffusion may not be sufficient to prevent instant fogging in a high humidity environment. If the absorption capacity is saturated ether kinetically or thermodynamically, the coating loses its AF effect. The water entrapped in the coating will also swell the coating layer and make the coating more susceptible to mechanical and chemical damage. Adhesion failure, or even delamination, often occurs when used in a high humidity environment. These mechanical failures are caused by water adsorption into the coating and the subsequent swelling of the coating resin. The other common strategy was designed to reduce water absorption by spreading condensed water droplets into a surface thin film via hydrophilic surfactants and a hydrophobic coating that migrate to the top surface during processing to produce the contact angle, and spread a water droplet(s) into a flat film.

Most anti-fog coatings on the market include incorporating mobile surfactants into a coating matrix. When moisture condensation occurs, the surfactants will either migrate to or orient towards the top surface to reduce the water-solid interfacial tension and the contact angle. As the surfactants are not chemically bonded to the coating structure, the surfactants will be washed off the surface either by repeated use or cleaning, leading to a fade-away AF effect. Therefore, they are suitable for providing only a temporary, i.e., not durable, AF effect. In addition, the surface is prone to damage and staining. Moreover, the plasticizing effect of the surfactant on the coating surface often makes the coating more vulnerable to abrasion and contamination.

Chemistries and coating processes for these coatings range from thermally cured coatings to ultraviolet (UV) cured coatings. Unfortunately, many of these conventional coatings have several drawbacks. For example, current anti-fog coatings are generally not long-lasting and often lose effectiveness after only a few lens cleanings. Moreover, many of these coatings require the use of a solvent and/or a primer that is undesirably high in VOC content. Furthermore, while thermally cured coatings may provide good scratch resistance, they also require long cure times and high energy consumption for solvent evaporation. Additionally, while UV cured coatings provide fast cure, energy savings, and high throughput production, their scratch resistance is generally poorer than with thermally cured coatings.

Accordingly, it is desirable to provide coating compositions that impart long-lasting anti-fog performance for transparent polymeric materials, methods for forming coated transparent polymeric materials using such coating compositions, and coated transparent polymeric materials with long-lasting anti-fog performance. Moreover, it is desirable to provide coating compositions that impart improved properties such as scratch and/or abrasion resistance, rapid curing, and/or relatively low solvent/VOC content, methods for forming coated transparent polymeric materials using such coating compositions, and coated transparent polymeric materials that include such coating compositions. Furthermore, other desirable features and characteristics of the present invention will become apparent from the subsequent detailed description and the appended claims, taken in conjunction with the accompanying drawings and this background.

### BRIEF SUMMARY

Hydrophilic and self cleaning UV nano-epoxy/acrylate cationic hybrid coating compositions for transparent polymeric materials, methods for coating transparent polymeric materials, and coated transparent polymeric materials are provided herein. In accordance with an exemplary embodiment, a coating composition for a transparent polymeric material comprises a cationically polymerizable compound, a radically polymerizable compound, a surfactant with both hydrophilic and hydrophobic segments, and a nano-sized particulate filler. The cationically polymerizable compound comprises at least one epoxy group. The radically polymerizable compound comprises at least one (meth)acrylate group and the nano-sized particulate filler comprises TiO₂, and SiO₂ and/or Al₂O₃.

In accordance with another exemplary embodiment, a method for forming a coated transparent polymeric material comprises preparing a coating composition. The coating composition comprises a cationically polymerizable compound, a radically polymerizable compound, a surfactant with both hydrophilic and hydrophobic segments, and a nano-sized particulate filler. The cationically polymerizable compound comprises at least one epoxy group. The radically polymerizable compound comprises at least one (meth)acrylate group and the nano-sized particulate filler comprises TiO₂, and SiO₂ and/or Al₂O₃. The coating composition is applied to a transparent polymeric material. The cationically polymerizable compound and the radically polymerizable compound are polymerized to form the coated transparent polymeric material.

In a further exemplary embodiment, a coated transparent polymeric material comprises a transparent polymeric material having a surface. A coating overlies the surface. The coating comprises a polymer matrix comprising a polymerized epoxy constituent and a polymerized (meth)acrylate constituent. A surfactant with both hydrophilic and hydrophobic segments is dispersed in the polymer matrix. A nano-sized particulate filler is dispersed in the polymer matrix and comprises TiO₂, and SiO₂ and/or Al₂O₃.

### DETAILED DESCRIPTION

The following Detailed Description is merely exemplary in nature and is not intended to limit the invention or the application and uses of the invention. Furthermore, there is no intention to be bound by any theory presented in the preceding background or the following detailed description.

In an exemplary embodiment, an improved coating system for transparent polymeric materials, such as ophthalmic lenses, provides improved characteristics in the form of anti-fog performance and scratch and/or abrasion resistance, while also providing improved manufacturability and rapid curing as compared to prior art coating systems. Generally, the coating system of the present disclosure is a composite coating that hybridizes both epoxy and acrylate coating materials into a single coating system that can have a relatively low VOC content. In this manner, the coating system exhibits the mechanical properties imparted by epoxies creating a highly abrasion resistant coating while also including the advantageous properties of radiation cured coatings imparted by acrylates in the form of rapid processing and curing as well as a superior vehicle for carrying additives.

In an exemplary embodiment, the additives include a nano-sized particulate filler that is dispersed throughout the composite coating and comprises TiO₂ particles, and SiO₂ particles and/or Al₂O₃ particles. The composite coating is applied to a surface of the transparent polymeric material, e.g., lens surface, and is polymerized (e.g. cured) to form a coated transparent polymeric material. When moisture condenses onto the surface of the coated transparent polymeric material, e.g., lens temperature is significantly cooler than the surrounding air temperature, the composite coating exhibits photo-induced hydrophilic and self-cleaning properties to impart long-lasting anti-fog performance to the transparent polymeric material. In particular, when the TiO₂ particles in the composite coating are exposed to light energy in the presence of moisture, the TiO₂ particles become energized and effectively convert localized moisture into hydroxyl radicals. The hydroxyl radicals act as powerful scrubbing agents that break up surface grime and oil and cause any water droplets to spread uniformly across the surface so that the transparent polymeric material remains transparent.

The SiO₂ and/or Al₂O₃ particles further enhance the mechanical properties imparted by the composite coating, not only improving the scratch and abrasion resistance of the coated transparent polymeric material but also helping to maintain the anti-fog performance imparted by the TiO₂ particles. In particular, the SiO₂ particles and Al₂O₃ particles improve the durability and robustness of the composite coating so that the coated transparent polymeric material is more resistant to lens cleaning and normal handling. This helps to improve the scratch and abrasion resistance of the coated transparent polymeric material and also to protect and maintain the effectiveness of the TiO₂ particles to provide even longer lasting anti-fog performance.

In the context of this disclosure, various optical terms are used to describe the transparent polymeric material, e.g., lens, ophthalmic lens, optical filter, and the like. To facilitate the understanding of the disclosure, some terms are initially defined as follows:

Lens: an ophthalmic lens that provides refractive correction or a lens that provides no refractive correction also known as a “plano lens”.

Visible light spectrum: energy emissions having a wavelength of between approximately 400 nm and 780 nm.

Visible light transmission (VLT): the percentage of light in the visible spectrum range that the filter of the present disclosure allows to pass through to the eyes of the user.

Blocking: a measure of the percentage of light that is either reflected by the surface or surface coatings or absorbed by the dye or plastic of the lens.

Substantially blocking: the point at which the filter of the present disclosure blocks over 99 percent of the incident radiation or transmits less than one-percent (1.0%) of the incident radiation at each and every wavelength within the defined range.

Infrared and near infrared: energy emissions having a wavelength on the order of between approximately 750 nm and 3000 nm.

The coating system of the present disclosure preferably includes a composition of nanocomposite binders and colloidal composite binders. The binder may include polymeric constituents selected from the group consisting of epoxy constituents, acrylate constituents, oxetane constituents, vinyl ethers, polios and a combination thereof. Further, the polymeric constituents may be thermally curable or curable using actinic radiation.

Further, the composite binders described herein may also preferably include particulate filler dispersed in a polymer matrix. Prior to curing, the composite binder formulation is typically a suspension that includes an external phase including organic polymeric constituents and, optionally, solvents. A polymeric constituent may be a monomer or a polymer in solvent. For example, the external phase may include monomers that polymerize upon curing. Alternatively or in addition, the external phase may include polymer material in a solvent. The particulate filler generally forms a dispersed phase within the external phase.

The particulate filler may be formed of inorganic particles, such as particles of, for example, a metal (such as, for example, steel, silver, or gold) or a metal complex such as, for example, a metal oxide, a metal hydroxide, a metal sulfide, a metal halogen complex, a metal carbide, a metal phosphate, an inorganic salt (like, for example, CaCO₃), a ceramic, or a combinations thereof. Examples of a metal oxide include ZnO, CdO, SiO₂, TiO₂, ZrO₂, CeO₂, SnO₂, MoO₃, WO₃, Al₂O₃, In₂O₃, La₂O₃, Fe₂O₃, C110, Ta₂O₅, Sb₂O₃, Sb₂O₅, or a combination thereof. A mixed oxide containing different metals may also be present. The nanoparticles may include, for example, particles of ZnO, SiO₂, TiO₂, ZrO₂, SnO₂, Al₂O₃, co-formed silica alumina and a mixture thereof. In an exemplary embodiment, the nanoparticles comprise TiO₂, and SiO₂ and/or Al₂O₃, for example TiO₂, SiO₂, and Al₂O₃. The nanometer sized particles may also have an organic component, such as, for example, carbon monotones, a highly cross linked/core shell polymer nanoparticle, an organically modified nanometer-size particle, etc. It should be appreciated that since this application is for ophthalmic applications, the coatings are optically clear, and, as a result, all the fillers are nanofillers so that they will not scatter the light.

Particulate filler formed via solution-based processes, such as sol-formed and sol-gel formed ceramics are particularly well suited for use in the composite binder. Suitable sols are commercially available. For example, colloidal silicas in aqueous solutions are commercially available under such trade designations as “LUDOX” (E. I. DuPont de Nemours and Co., Inc. Wilmington, Del.), “NYACOL” (available from Nyacol Co., Ashland, Mass.) and “NALCO” (available from Nalco Chemical Co., Oak Brook, Ill.). Many commercially available sols are basic, being stabilized by alkali, such as sodium hydroxide, potassium hydroxide, or ammonium hydroxide. Cationic polymerization cannot use basic solution since cationic photoinititator generates strong acid to open the epoxy ring for polymerization. Additional examples of suitable colloidal silicas are described in U.S. Pat. No. 5,126,394, incorporated herein by reference. Especially well-suited are sol-formed silica and sol-formed alumina. The sols can be functionalized by reacting one or more appropriate surface-treatment agents with the inorganic oxide substrate particles in the sol.

In a particular embodiment, the particulate filler is sub-micron sized. For example, the particulate filler may be a nano-sized particulate filler, such as a particulate filler having an average particle size of about 3 mm to about 500 nm. In an exemplary embodiment, the particulate filler has an average particle size of from about 3 nm to about 200 nm, such as from about 3 nm to about 100 nm, about 3 nm to about 50 nm, about 8 nm to about 30 nm, or about 10 nm to about 25 nm. In particular embodiments, the average particle size is not greater than about 500 nm, such as not greater than about 200 nm, less than about 100 nm, or not greater than about 50 nm. In an exemplary embodiment, the particulate filler comprises particles of TiO₂, and SiO₂ and/or Al₂O₃, such as TiO₂, SiO₂, and Al₂O₃, having an average particle size of about 100 nm or less. For the particulate filler, the average particle size may be defined as the particle size corresponding to the peak volume fraction in a small-angle neutron scattering (SANS) distribution curve or the particle size corresponding to 0.5 cumulative volume fraction of the SANS distribution curve.

The particulate filler may also be characterized by a narrow distribution curve having a half-width not greater than about 2.0 times the average particle size. For example, the half-width may be not greater than about 1.5 or not greater than about 1.0. The half-width of the distribution is the width of the distribution curve at half its maximum height, such as half of the particle fraction at the distribution curve peak. In a particular embodiment, the particle size distribution curve is mono-modal. In an alternative embodiment, the particle size distribution is bi-modal or has more than one peak in the particle size distribution.

In a particular embodiment, the particles of the particulate filler are substantially spherical. Alternatively, the particles may have a primary aspect ratio greater than 1, such as at least about 2, at least about 3, or at least about 6, wherein the primary aspect ratio is the ratio of the longest dimension to the smallest dimension orthogonal to the longest dimension. The particles may also be characterized by a secondary aspect ratio defined as the ratio of orthogonal dimensions in a plane generally perpendicular to the longest dimension. The particles may be needle-shaped, such as having a primary aspect ratio at least about 2 and a secondary aspect ratio not greater than about 2, such as about 1. Alternatively, the particles may be platelet-shaped, such as having an aspect ratio at least about 2 and a secondary aspect ratio at least about 2.

In an exemplary embodiment, the particulate filler is prepared in an aqueous solution and mixed with an external phase of the suspension. The process for preparing such suspension includes introducing an aqueous solution, such as an aqueous silica solution; polycondensing the silicate, such as to a particle size of 3 nm to 50 nm; adjusting the resulting silica sol to an alkaline pH; optionally concentrating the sol; mixing the sol with constituents of the external fluid phase of the suspension; and optionally removing water or other solvent constituents from the suspension. For example, an aqueous silicate solution is introduced, such as an alkali metal silicate solution (e.g., a sodium silicate or potassium silicate solution) with a concentration in the range between 20% and 50% by weight based on the weight of the solution. The silicate is polycondensed to a particle size of 3 nm to 50 nm, for example, by treating the alkali metal silicate solution with acidic ion exchangers. The resulting silica sol is adjusted to an alkaline pH (e.g., pH>8) to stabilize against further polycondensation or agglomeration of existing particles. Optionally, the sol can be concentrated, for example, by distillation, typically to SiO₂ concentration of about 30 to 40% by weight. The sol is mixed with constituents of the external fluid phase. Thereafter, water or other solvent constituents are removed from the suspension. In a particular embodiment, the suspension is substantially water-free.

The fraction of the external phase in the pre-cured binder formulation, generally including the organic polymeric constituents, as a proportion of the binder formulation can be about 5% to about 95% by weight, such as about 20% to about 95% by weight, for example, about 30% to about 95% by weight, and typically from about 50% to about 95% by weight, and even more typically from about 55% to about 80% by weight. The fraction of the dispersed particulate filler phase can be about 5% to about 95% by weight, such as about 5% to about 80% by weight, for example, about 5% to about 70% by weight, typically from about 5% to about 50% by weight, and more typically from about 20% to about 45% by weight. The colloidally dispersed and submicron particulate fillers described above are particularly useful in concentrations of at least about 5 weight % (wt. %), such as at least about 10 wt. %, at least about 15 wt. %, at least about 20 wt. %, or as great as 40 wt. % or higher. In an exemplary embodiment, the colloidally dispersed and submicron particulate fillers comprise TiO₂, and SiO₂ and/or Al₂O₃, and are in concentrations of from about 5 wt. % to about 95 wt. %. In an exemplary embodiment, the TiO₂ is in a concentration of about 20 wt. %, such as about 10 wt. %, for example of from about 1 to about 5 wt. %. In another exemplary embodiment, the SiO₂ is in a concentration of about 60 wt. % or less, for example of from about 1 to about 20 wt. %. In another exemplary embodiment, the Al₂O₃ is in a concentration of about 20 wt. % or less, for example of from about 1 to about 10 wt. %. In contrast with traditional fillers, the solution formed of nanocomposites exhibit low viscosity and improved processing characteristics at higher loading. The amounts of components are expressed as weight % of the component relative to the total weight of the composite binder formulation, unless explicitly stated otherwise.

The external phase may include one or more reaction constituents or polymer constituents for the preparation of a polymer. A polymer constituent may include monomeric molecules, polymeric molecules or a combination thereof. The external phase may further comprise components selected from the group consisting of solvents, plasticizers, chain transfer agents, catalysts, stabilizers, dispersants, curing agents, reaction mediators and agents for influencing the fluidity of the dispersion.

The polymer constituents can form thermoplastics or thermosets. By way of example, the polymer constituents may include monomers and resins for the formation of polyurethane, polyurea, polymerized epoxy, polyester, polyimide, polysiloxanes (silicones), polymerized alkyd, styrene-butadiene rubber, acrylonitrile-butadiene rubber, polybutadiene, or, in general, reactive resins for the production of thermoset polymers. Another example includes an acrylate or a methacrylate polymer constituent. The precursor polymer constituents are typically curable organic material (i.e., a polymer monomer or material capable of polymerizing or crosslinking upon exposure to heat or other sources of energy, such as electron beam, ultraviolet light, visible light, etc., or with time upon the addition of a chemical catalyst, moisture, or other agent which cause the polymer to cure or polymerize). A precursor polymer constituent example includes a reactive constituent for the formation of an amino polymer or an aminoplast polymer, such as alkylated urea-formaldehyde polymer, melamine-formaldehyde polymer, and alkylated benzoguanamine-formaldehyde polymer; acrylate polymer including acrylate and methacrylate polymer, alkyl acrylate, acrylated epoxy, acrylated urethane, acrylated polyester, acrylated polyether, vinyl ether, acrylated oil, or acrylated silicone; alkyd polymer such as urethane alkyd polymer; polyester polymer; reactive urethane polymer; phenolic polymer such as resole and novolac polymer; phenolic/latex polymer; epoxy polymer such as bisphenol epoxy polymer; isocyanate; isocyanurate; polysiloxane polymer including alkylalkoxysilane polymer; or reactive vinyl polymer. The external phase of the binder formulation may include a monomer, an oligomer, a polymer, or a combination thereof. In a particular embodiment, the external phase of the binder formulation includes monomers of at least two types of polymers that when cured may crosslink. For example, the external phase may include epoxy constituents and acrylic constituents that when cured form an epoxy/acrylic polymer.

In an exemplary embodiment, the polymer reaction components include anionically and cationically polymerizable precursors. For example, the external phase may include at least one cationically curable component, e.g., at least one cyclic ether component, cyclic lactone component, cyclic acetal component, cyclic thioether component, spiro orthoester component, epoxy-functional component, or oxetane-functional component. Typically, the external phase includes at least one component selected from the group consisting of epoxy-functional components and oxetane-functional components. The external phase may include, relative to the total weight of the composite binder formulation, at least about 10 wt. % of cationically curable components, for example, at least about 20 wt. %, typically at least about 40 wt. %, or at least about 50 wt. %. Generally, the external phase includes, relative to the total weight of the composite binder formulation, not greater than about 95 wt. % of cationically curable components, for example, not greater than about 90 wt. %, not greater than about 80 wt. %, or not greater than about 70 wt. %.

In an optional embodiment, the external phase may include at least one epoxy-functional component, e.g., an aromatic-epoxy-functional component (“aromatic epoxy or more preferably an aliphatic epoxy-functional component (“aliphatic epoxy”). Epoxy-functional components are components comprising one or more epoxy groups, i.e., one or more three-member ring structures (oxiranes).

Aromatic epoxy components include one or more epoxy groups and one or more aromatic rings. The external phase may include one or more aromatic epoxy components. An example of an aromatic epoxy component includes an aromatic epoxy derived from a polyphenol, e.g., from bisphenols, such as bisphenol A (4,4′-isopropylidenediphenol), bisphenol F (bis[4-hydroxyphenyl]methane), bisphenol S (4,4′-sulfonyldiphenol), 4,4′-cyclohexylidenebisphenol, 4,4′-biphenol, or 4,4′-(9-fluorenylidene)diphenol. The bisphenol may be alkoxylated (e.g., ethoxylated or propoxylated) or halogenated (e.g., brominated). Examples of bisphenol epoxies include bisphenol diglycidyl ethers, such as diglycidyl ether of Bisphenol A or Bisphenol F.

A further example of an aromatic epoxy includes triphenylolmethane triglycidyl ether, 1,1,1-tris(p-hydroxyphenyl)ethane triglycidyl ether, or an aromatic epoxy derived from a monophenol, e.g., from resorcinol (for example, resorcin diglycidyl ether) or hydroquinone (for example, hydroquinone diglycidyl ether). Another example is nonylphenyl glycidyl ether.

In addition, an example of an aromatic epoxy includes epoxy novolac, for example, phenol epoxy novolac and cresol epoxy novolac. A commercial example of a cresol epoxy novolac includes, for example, EPICLON N-660, N-665, N-667, N-670, N-673, N-680, N-690, or N-695, manufactured by Dainippon Ink and Chemicals, Inc. An example of a phenol epoxy novolac includes, for example, EPICLON N-740, N-770, N-775, or N-865, manufactured by Dainippon Ink and Chemicals Inc.

In one embodiment, the external phase may contain, relative to the total weight of the composite binder formulation, at least 10 wt. % of one or more aromatic epoxies.

Aliphatic epoxy components have one or more epoxy groups and are free of aromatic rings. The external phase may include one or more aliphatic epoxies. An example of an aliphatic epoxy includes glycidyl ether of C2-C30 alkyl; 1,2 epoxy of C3-C30 alkyl; mono or multi glycidyl ether of an aliphatic alcohol or polyol such as 1,4-butanediol, neopentyl glycol, cyclohexane dimethanol, dibromo neopentyl glycol, trimethylol propane, polytetramethylene oxide, polyethylene oxide, polypropylene oxide, glycerol, and alkoxylated aliphatic alcohols; or polyols.

In one embodiment, the aliphatic epoxy includes one or more cycloaliphatic ring structures. For example, the aliphatic epoxy may have one or more cyclohexene oxide structures, for example, two cyclohexene oxide structures. An example of an aliphatic epoxy comprising a ring structure includes hydrogenated bisphenol A diglycidyl ether, hydrogenated bisphenol F diglycidyl ether, hydrogenated bisphenol S diglycidyl ether, bis(4-hydroxycyclohexyl)methane diglycidyl ether, 2,2-bis(4-hydroxycyclohexyl)propane diglycidyl ether, 3,4-epoxycyclohexylmethyl-3,4-epoxycyclohexanecarboxylate, 3,4-epoxy-6-methylcyclohexylmethyl-3,4-epoxy-6-methylcyclohexanecarboxylate, di(3,4-epoxycyclohexylmethyl)hexanedioate, di(3,4-epoxy-6-methylcyclohexyl methyl) hexanedioate, ethylenebis(3,4-epoxycyclohexanecarboxylate), ethanedioldi(3,4-epoxycyclohexylmethyl)ether, or 2-(3,4-epoxycyclohexyl-5,5-spiro-3,4-epoxy)cyclohexane-1,3-dioxane.

In an embodiment, the external phase includes, relative to the total weight of the composite binder formulation, at least about 5 wt. % of one or more aliphatic epoxies, for example, at least about 10 wt. % or at least about 20 wt. % of the aliphatic epoxy. Generally, the external phase includes, relative to the total weight of the composite binder formulation, not greater than about 70 wt. % of the aliphatic epoxy, for example, not greater than about 50 wt. %, for example not greater than about 40 wt. %.

Typically, the external phase includes one or more mono or poly glycidylethers of aliphatic alcohols, aliphatic polyols, polyesterpolyols or polyetherpolyols. An example of such a component includes 1,4-butanedioldiglycidylether, glycidylether of polyoxyethylene or polyoxypropylene glycol or triol of molecular weight from about 200 to about 10,000; glycidylether of polytetramethylene glycol or poly(oxyethylene-oxybutylene) random or block copolymers. An example of commercially available glycidylether includes a polyfunctional glycidylether, such as Heloxy 48, Heloxy 67, Heloxy 68, Heloxy 107, and Grilonit F713; or monofunctional glycidylethers, such as Heloxy 71, Heloxy 505, Heloxy 7, Heloxy 8, and Heloxy 61 (sold by Resolution Performances, www.resins.com).

The external phase may contain about 3 wt. % to about 40 wt. %, more typically about 5 wt. % to about 20 wt. % of mono or poly glycidyl ethers of an aliphatic alcohol, aliphatic polyol, polyesterpolyol or polyetherpolyol.

The external phase may include one or more oxetane-functional components (“oxetanes”). Oxetanes are components having one or more oxetane groups, i.e., one or more four-member ring structures including one oxygen and three carbon members.

In addition to or instead of one or more cationically curable components, the external phase may include one or more free radical curable components, e.g., one or more free radical polymerizable components having one or more ethylenically unsaturated groups, such as (meth)acrylate (i.e., acrylate or methacrylate) functional components.

An example of a monofunctional ethylenically unsaturated component includes acrylamide, N,N-dimethylacrylamide, (meth)acryloylmorpholine, 7-amino-3,7-dimethyloctyl(meth)acrylate, isobutoxymethyl(meth)acrylamide, isobornyloxyethyl (meth)acrylate, isobornyl(meth)acrylate, 2-ethylhexyl(meth)acrylate, ethyldiethylene glycol (meth)acrylate, t-octyl(meth)acrylamide, diacetone (meth)acrylamide, dimethylaminoethyl(meth)acrylate, diethylaminoethyl(meth)acrylate, lauryl (meth)acrylate, dicyclopentadiene (meth)acrylate, dicyclopentenyloxyethyl(meth)acrylate, dicyclopentenyl(meth)acrylate, N,N-dimethyl(meth) acrylamidetetrachlorophenyl (meth)acrylate, 2-tetrachlorophenoxyethyl(meth)acrylate, tetrahydrofurfuryl(meth)acrylate, tetrabromophenyl(meth)acrylate, 2-tetrabromophenoxyethyl(meth)acrylate, 2-trichlorophenoxyethyl(meth)acrylate, tribromophenyl(meth)acrylate, 2-tribromophenoxyethyl(meth)acrylate, 2-hydroxyethyl (meth)acrylate, 2-hydroxypropyl(meth)acrylate, vinylcaprolactam, N-vinylpyrrolidone, phenoxyethyl(meth)acrylate, butoxyethyl(meth)acrylate, pentachlorophenyl (meth)acrylate, pentabromophenyl(meth)acrylate, polyethylene glycol mono(meth)acrylate, polypropylene glycol mono(meth)acrylate, bornyl(meth)acrylate, methyltriethylene diglycol (meth)acrylate, or a combination thereof.

An examples of the polyfunctional ethylenically unsaturated component includes ethylene glycol di(meth)acrylate, dicyclopentenyl di(meth)acrylate, triethylene glycol diacrylate, tetraethylene glycol di(meth)acrylate, tricyclodecanediyldimethylene di(meth)acrylate, trimethylolpropane tri(meth)acrylate, ethoxylated trimethylolpropane tri(meth)acrylate, propoxylated trimethylolpropane tri(meth)acrylate, tripropylene glycol di(meth)acrylate, neopentyl glycol di(meth)acrylate, both-terminal (meth)acrylic acid adduct of bisphenol A diglycidyl ether, 1,4-butanediol di(meth)acrylate, 1,6-hexanediol di(meth)acrylate, polyethylene glycol di(meth)acrylate, (meth)acrylate-functional pentaerythritol derivatives (e.g., pentaerythritol tri(meth)acrylate, pentaerythritol tetra(meth)acrylate, d ipentaerythritol hexa(meth)acrylate, dipentaerythritol penta(meth)acrylate, or dipentaerythritol tetra(meth)acrylate), ditrimethylolpropane tetra(meth)acrylate, ethoxylated bisphenol A di(meth)acrylate, propoxylated bisphenol A di(meth)acrylate, ethoxylated hydrogenated bisphenol A di(meth)acrylate, propoxylated-modified hydrogenated bisphenol A di(meth)acrylate, ethoxylated bisphenol F di(meth)acrylate, or a combination thereof.

In one embodiment, the binder formulation comprises one or more components having at least 3 (meth)acrylate groups, for example, 3 to 6 (meth)acrylate groups or 5 to 6 (meth)acrylate groups.

In particular embodiments, the external phase includes, relative to the total weight of the composite binder formulation, at least about 3 wt. % of one or more free radical polymerizable components, for example, at least about 5 wt. %, for example at least about 9 wt. %. Generally, the external phase includes not greater than about 50 wt. % of free radical polymerizable components, for example, not greater than about 35 wt. %, for example, not greater than about 25 wt. %, for example not greater than about 20 wt. %, for example not greater than about 15 wt. %.

Generally, the polymer reaction constituents or precursors have on average at least two functional groups, such as on average at least 2.5, for example at least 3.0 functional groups. For example, an epoxy precursor may have 2 or more epoxy-functional groups. In another example, an acrylic precursor may have two or more methacrylate functional groups.

It has been found that an external phase including a component having a polyether backbone shows excellent mechanical properties after cure of the composite binder formulation. An example of a compound having a polyether backbone includes polytetramethylenediol, a glycidylether of polytetramethylenediol, an acrylate of polytetramethylenediol, a polytetramethylenediol containing one or more polycarbonate groups, or a combination thereof. In an embodiment, the external phase includes between 5 wt. % and 20 wt. % of a compound having a polyether backbone.

The external phase may also include catalysts and initiators. For example, a cationic initiator may catalyze reactions between cationic polymerizable constituents. A radical initiator may activate free-radical polymerization of radiacally polymerizable constituents. The initiator may be activated by thermal energy or actinic radiation. For example, an initiator may include a cationic photoinitiator that catalyzes cationic polymerization reactions when exposed to actinic radiation. In another example, the initiator may include a radical photoinitiator that initiates free-radical polymerization reactions when exposed to actinic radiation. Actinic radiation includes particulate or non-particulate radiation and is intended to include electron beam radiation and electromagnetic radiation. In a particular embodiment, electromagnetic radiation includes radiation having at least one wavelength in the range of about 100 nm to about 700 nm and, in particular, wavelengths in the ultraviolet range of the electromagnetic spectrum.

Generally, cationic photoinitiators are materials that form active species that, if exposed to actinic radiation, are capable of at least partially polymerizing epoxides or oxetanes. For example, a cationic photoinitiator may, upon exposure to actinic radiation, form cations that can initiate the reactions of cationically polymerizable components, such as epoxies or oxetanes.

An example of a cationic photoinitiator includes, for example, onium salt with anions of weak nucleophilicity. An example includes a halonium salt, an iodosyl salt or a sulfonium salt, a sulfoxonium salt, or a diazonium salt. Other examples of cationic photoinitiators include metallocene salt.

The external phase may optionally include photoinitiators useful for photocuring free-radically polyfunctional acrylates. An example of a free radical photoinitiator includes benzophenone (e.g., benzophenone, alkyl-substituted benzophenone, or alkoxy-substituted benzophenone); benzoin (e.g., benzoin, benzoin ethers, such as benzoin methyl ether, benzoin ethyl ether, and benzoin isopropyl ether, benzoin phenyl ether, and benzoin acetate); acetophenone, such as acetophenone, 2,2-dimethoxyacetophenone, 4-(phenylthio)acetophenone, and 1,1-dichloroacetophenone; benzil ketal, such as benzil dimethyl ketal, and benzil diethyl ketal; anthraquinone, such as 2-methylanthraquinone, 2-ethylanthraquinone, 2-tertbutylanthraquinone, 1-chloroanthraquinone, and 2-amylanthraquinone; triphenylphosphine; benzoylphosphine oxides, such as, for example, 2,4,6-trimethylbenzoyldiphenylphosphine oxide; thioxanthone or xanthone; acridine derivative; phenazene derivative; quinoxaline derivative; 1-phenyl-1,2-propanedione-2-β-benzoyloxime; 1-aminophenyl ketone or 1-hydroxyphenyl ketone, such as 1-hydroxycyclohexyl phenyl ketone, phenyl(1-hydroxyisopropyl)ketone and 4-isopropylphenyl(1-hydroxyisopropyl)ketone; or a triazine compound, for example, 4′″-methyl thiophenyl-1-di(trichloromethyl)-3,5-S-triazine, S-triazine-2-(stilbene)-4,6-bistrichloromethyl, or paramethoxy styryl triazine.

An exemplary photoinitiator includes benzoin or its derivative such as α-methylbenzoin; U-phenylbenzoin; α-allylbenzoin; α-benzylbenzoin; benzoin ethers such as benzil dimethyl ketal (available, for example, under the trade designation “IRGACURE 651” from Ciba Specialty Chemicals), benzoin methyl ether, benzoin ethyl ether, benzoin n-butyl ether; acetophenone or its derivative, such as 2-hydroxy-2-methyl-1-phenyl-1-propanone (available, for example, under the trade designation “DAROCUR 1173” from Ciba Specialty Chemicals) and 1-hydroxycyclohexyl phenyl ketone (available, for example, under the trade designation “IRGACURE 184” from Ciba Specialty Chemicals); 2-methyl-1-[4-(methylthio) phenyl]-2-(4-morpholinyl)-1-propanone (available, for example, under the trade designation “IRGACURE 907” from Ciba Specialty Chemicals); 2-benzyl-2-(dimethlamino)-1[4-(4-morpholinyl)phenyl]-1-butanone (available, for example, under the trade designation “IRGACURE 369” from Ciba Specialty Chemicals); or a blend thereof.

Another useful photoinitiator includes pivaloin ethyl ether, anisoin ethyl ether; anthraquinones, such as anthraquinone, 2-ethylanthraquinone, 1-chloroanthraquinone, 1,4-dimethylanthraquinone, 1-methoxyanthraquinone, benzanthraquinonehalomethyltriazines, and the like; benzophenone or its derivative; iodonium salt or sulfonium salt as described hereinabove; a titanium complex such as bis(5-2,4-cyclopentadienyl)bis[2,-6-difluoro-3-(1 H-pyrrolyl)phenyl)titanium (commercially available under the trade designation “CGI784DC”, also from Ciba Specialty Chemicals); a halomethylnitrobenzene such as 4-bromomethylnitrobenzene and the like; or mono- or bis-acylphosphine (available, for example, from Ciba Specialty Chemicals under the trade designations “IRGACURE 1700”, “IRGACURE 1800”, “IRGACURE 1850”, and “DAROCUR 4265”). A suitable photoinitiator may include a blend of the above mentioned species, such as α-hydroxy ketone/acrylphosphin oxide blend (available, for example, under the trade designation IRGACURE 2022 from Ciba Specialty Chemicals).

A further suitable free radical photoinitiator includes an ionic dye-counter ion compound, which is capable of absorbing actinic rays and producing free radicals, which can initiate the polymerization of the acrylates.

A photoinitiator can be present in an amount not greater than about 20 wt. %, for example, not greater than about 10 wt. %, and typically not greater than about 5 wt. %, based on the total weight of the binder formulation. For example, a photoinitiator may be present in an amount of 0.1 wt. % to 20.0 wt. %, such as 0.1 wt. % to 5.0 wt. %, or most typically 0.1 wt. % to 2.0 wt. %, based on the total weight of the binder formulation, although amounts outside of these ranges may also be useful. In one example, the photoinitiator is present in an amount at least about 0.1 wt. %, such as at least about 1.0 wt. %, for example in an amount 1.0 wt. % to 10.0 wt. %.

Optionally, a thermal curative may be included in the external phase. Such a thermal curative is generally thermally stable at temperatures at which mixing of the components takes place. Exemplary thermal curatives for epoxy resins and acrylates are well known in the art. A thermal curative may be present in a binder precursor in any effective amount. Such amounts are typically in the range of about 0.01 wt. % to about 5.0 wt. %, desirably in the range from about 0.025 wt. % to about 2.0 wt. % by weight, based upon the weight of the binder formulation, although amounts outside of these ranges may also be useful.

The external phase may also include other components such as solvents, plasticizers, crosslinkers, chain transfer agents, stabilizers, dispersants, curing agents, reaction mediators and agents for influencing the fluidity of the dispersion. For example, the external phase can also include one or more chain transfer agents selected from the group consisting of polyol, polyamine, linear or branched polyglycol ether, polyester and polylactone.

In another example, the external phase may include additional components, such as a hydroxy-functional or an amine functional component and additive. Generally, the particular hydroxy-functional component is absent curable groups (such as, for example, acrylate-, epoxy-, or oxetane groups) and is not selected from the group consisting of photoinitiators.

The external phase may include one or more hydroxy-functional components. Hydroxy-functional components may be helpful in further tailoring mechanical properties of the binder formulation upon cure. An hydroxy-functional component includes monol (a hydroxy-functional component comprising one hydroxy group) or polyol (a hydroxy-functional component comprising more than one hydroxy group).

A representative example of a hydroxy-functional component includes an alkanol, a monoalkyl ether of polyoxyalkyleneglycol, a monoalkyl ether of alkyleneglycol, alkylene and arylalkylene glycol, such as 1,2,4-butanetriol, 1,2,6-hexanetriol, 1,2,3-heptanetriol, 2,6-dimethyl-1,2,6-hexanetriol, (2R,3R)-(−)-2-benzyloxy-1,3,4-butanetriol, 1,2,3-hexanetriol, 1,2,3-butanetriol, 3-methyl-1,3,5-pentanetriol, 1,2,3-cyclohexanetriol, 1,3,5-cyclohexanetriol, 3,7,11,15-tetramethyl-1,2,3-hexadecanetriol, 2-hydroxymethyltetrahydropyran-3,4,5-triol, 2,2,4,4-tetramethyl-1,3-cyclobutanediol, 1,3-cyclopentanediol, trans-1,2-cyclooctanediol, 1,16-hexadecanediol, 3,6-dithia-1,8-octanediol, 2-butyne-1,4-diol, 1,2- or 1,3-propanediol, 1,2- or 1,4-butanediol, 1,5-pentanediol, 1,6-hexanediol, 1,7-heptanediol, 1,8-octanediol, 1,9-nonanediol, 1-phenyl-1,2-ethanediol, 1,2-cyclohexanediol, 1,5-decalindiol, 2,5-dimethyl-3-hexyne-2,5-diol, 2,2,4-trimethylpentane-1,3-diol, neopentylglycol, 2-ethyl-1,3-hexanediol, 2,7-dimethyl-3,5-octadiyne-2-7-diol, 2,3-butanediol, 1,4-cyclohexanedimethanol, polyoxyethylene or polyoxypropylene glycols or triols of molecular weights from about 200 to about 10,000, polytetramethylene glycols of varying molecular weight, poly(oxyethylene-oxybutylene) random or block copolymers, copolymers containing pendant hydroxy groups formed by hydrolysis or partial hydrolysis of vinyl acetate copolymers, polyvinylacetal resins containing pendant hydroxyl groups, hydroxy-functional (e.g., hydroxy-terminated) polyesters or hydroxy-functional (e.g., hydroxy-terminated) polylactones, aliphatic polycarbonate polyols (e.g., an aliphatic polycarbonate diol), hydroxy-functional (e.g., hydroxy-terminated) polyethers (e.g., polytetrahydrofuran polyols having a number average molecular weight in the range of 150-4000 g/mol, 150-1500 g/mol, or 150-750 g/mol), or a combination thereof. Exemplary polyols further include aliphatic polyol, such as glycerol, trimethylolpropane, and also sugar alcohol, such as erythritol, xylitol, mannitol or sorbitol. In particular embodiments, the external phase of the binder formulation includes one or more alicyclic polyols, such as 1,4-cyclohexane-dimethanol, sucrose, or 4,8-bis(hydroxymethyl)tricyclo(5,2,1,0)decane.

A suitable polyether for the external phase includes, in particular, linear or branched polyglycol ether obtainable by ring-opening polymerization of cyclic ether in the presence of polyol, e.g., the aforementioned polyol; polyglycol ether, polyethylene glycol, polypropylene glycol or polytetramethylene glycol or a copolymer thereof.

Another suitable polyester for the external phase of the formulation includes a polyester based on polyols and aliphatic, cycloaliphatic or aromatic polyfunctional carboxylic acids (for example, dicarboxylic acids), or specifically all corresponding saturated polyesters which are liquid at temperatures of 18° C. to 300° C., typically 18° C. to 150° C.: typically succinic ester, glutaric ester, adipic ester, citric ester, phthalic ester, isophthalic ester, terephthalic ester or an ester of corresponding hydrogenation products, with the alcohol component being composed of monomeric or polymeric polyols, for example, of those of the above-mentioned kind.

Further polyester includes aliphatic polylactone, such as α-polycaprolactone, or polycarbonate, which, for example, are obtainable by polycondensation of diol with phosgene. For the external phase it is typical to use polycarbonate of bisphenol A having an average molecular weight of from 500 to 100,000.

For the purpose of influencing the viscosity of the external phase and, in particular, viscosity reduction or liquefaction, the polyol, polyether or saturated polyester or mixtures thereof may, where appropriate, be admixed with a further suitable auxiliary, particularly a solvent, a plasticizer, a diluent or the like. In an embodiment, the compositions may comprise, relative to the total weight of the binder formulation, not greater than about 15 wt. %, such as not greater than about 10 wt. %, not greater than about 6 wt. %, not greater than about 4 wt. %, not greater than about 2 wt. %, or about 0 wt. % of a hydroxy-functional component. In one example, the binder formulations are free of substantial amounts of a hydroxy-functional component. The absence of substantial amounts of hydroxy-functional components may decrease the hygroscopicity of the binder formulations or articles obtained therewith.

An example of a hydroxyl or an amine functional organic compound for making condensation product with an alkylene oxide includes a polyol having 3 to 20 carbon atoms, a (C8-C18) fatty acid (C1-C8) alkanol amides like fatty acid ethanol amides, a fatty alcohol, an alkylphenol or a diamine having 2 to 5 carbon atoms. Such compounds are reacted with alkylene oxide, such as ethylene oxide, propylene oxide or mixtures thereof. The reaction may take place in a molar ratio of hydroxy or amine containing organic compound to alkyleneoxide of, for example, 1:2 to 1:65. The condensation product typically has a weight average molecular weight of about 500 to about 10,000, and may be branched, cyclic, linear, and either a homopolymer, a copolymer or a terpolymer.

The external phase may further include a dispersant for interacting with and modifying the surface of the particulate filler. For example, a dispersant may include organosiloxane, functionalized organisiloxane, alkyl-substituted pyrrolidone, polyoxyalkylene ether, ethyleneoxide propyleneoxide copolymer or a combination thereof. For various particulate fillers and, in particular, for silica filler, a suitable surface modifier includes siloxane.

In general, the functionalized siloxane is a compound having a molecular weight ranging from about 300 to about 20,000. Such compounds are commercially available from, for example, the General Electric Company or from Goldschmidt, Inc. A typical functionalized siloxane is an amine functionalized siloxane wherein the functionalization is typically terminal to the siloxane.

Exemplary organosiloxanes are sold under the name Silwet by Witco Corporation. Such organosiloxanes typically have an average weight molecular weight of about 350 to about 15,000, are hydrogen or C1-C4 alkyl capped and may be hydrolyzable or non-hydrolyzable. Typical organosiloxanes include those sold under the name of Silwet L-77, L-7602, L-7604 and L-7605, which are polyalkylene oxide modified dialkyl polysiloxanes.

An example of a suitable anionic dispersant includes (C8-C16)alkylbenzene sulfonate, (C8-C16)alkane sulfonate, (C8-C18) α-olefin sulfonate, α-sulfo (C8-C16) fatty acid methyl ester, (C8-C16) fatty alcohol sulfate, mono- or di-alkyl sulfosuccinate with each alkyl independently being a (C8-C16)alkyl group, alkyl ether sulfate, a (C8-C16) salt of carboxylic acid or isethionate having a fatty chain of about 8 to about 18 carbons, for example, sodium diethylhexyl sulfosuccinate, sodium methyl benzene sulfonate, or sodium bis(2-ethylhexyl)sulfosuccinate (for example, Aerosol OT or AOT).

Typically, the dispersant is a compound selected from an organosiloxane, a functionalised organosiloxane, an alkyl-substituted pyrrolidone, a polyoxyalkylene ether, or a ethyleneoxide propylenenoxide block copolymer.

An example of a commercial dispersant includes a cyclic organo-silicone (e.g., SF1204, SF1256, SF1328, SF1202 (decamethyl-cyclopentasiloxane(pentamer)), SF1258, SF1528, Dow Corning 245 fluids, Dow Corning 246 fluids, dodecamethyl-cyclo-hexasiloxane (heximer), and SF 1173); a copolymer of a polydimethylsiloxane and a polyoxyalkylene oxide (e.g., SF1488 and SF1288); linear silicon comprising oligomers (e.g., Dow Corning 200 (R) fluids); Silwet L-7200, Silwet L-7600, Silwet L-7602, Silwet L-7605, Silwet L-7608, or Silwet L-7622; a nonionic surfactants (e.g., Triton X-100, Igepal CO-630, PVP series, Airvol 125, Airvol 305, Airvol 502 and Airvol 205); an organic polyether (e.g., Surfynol 420, Surfynol 440 and Surfynol 465); or Solsperse 41000.

Another exemplary commercial dispersant includes SF1173 (from GE Silicones); an organic polyether like Surfynol 420, Surfynol 440, and Surfynol 465 (from Air Products Inc); Silwet L-7200, Silwet L-7600, Silwet L-7602, Silwet L-7605, Silwet L-7608, or Silwet L-7622 (from Witco) or non-ionic surfactant such as Triton X-100 (from Dow Chemicals), Igepal CO-630 (from Rhodia), PVP series (from ISP Technologies) and Solsperse 41000 (from Avecia).

The amount of dispersant ranges from 0 wt. % to 5 wt. %. More typically, the amount of dispersant is between 0.1 wt. % and 2 wt. %. The silanes are typically used in concentrations from 40 mol. % to 200 mol. % and, particularly, 60 mol. % to 150 mol. % relative to the molecular quantity surface active sites on the surface of the nano-sized particulate filler. Generally, the binder formulation includes not greater than about 5 wt. % dispersant, such as about 0.1 wt. % to about 5.0 wt. % dispersant, based on the total weight of the binder formulation.

In a particular embodiment, the binder formulation includes about 10 wt. % to about 90 wt. % cationically polymerizable compound, not greater than about 40 wt. % radically polymerizable compound, and about 5 wt. % to about 80 wt. % particulate filler, based on the total weight of the binder formulation. It is understood that the sum of the amounts of the binder formulation components adds to 100 wt. % and, as such, when amounts of one or more components are specified, the amounts of other components correspond so that the sum of the amounts is not greater than 100 wt. %. In an exemplary embodiment, a weight ratio of the cationically polymerizable compound to the radically polymerizable compound is from about 1:1 to about 2:1.

The cationically polymerizable compound, for example, includes an epoxy-functional component or an oxetane-functional component. For example, the binder formulation may include about 10 wt. % to about 60 wt. % cationically polymerizable compound, such as about 20 wt. % to about 50 wt. % cationically polymerizable compound based on the weight of the binder formulation. The exemplary binder formulation may include not greater than about 20 wt. %, such as about 5 wt. % to about 20 wt. % mono or poly glycidyl ethers of an aliphatic alcohol, aliphatic polyols, polyesterpolyol or polyetherpolyol. The exemplary binder formulation may include not greater than about 50 wt. %, such as about 5 wt. % to about 50 wt. % of a component having a polyether backbone, such as polytetramethylenediol, glycidylethers of polytetramethylenediol, and acrylates of polytetramethylenediol or polytetramethylenediol containing one or more polycarbonate groups.

The radically polymerizable compound of the above example, for example, includes components having one or more methacylate groups, such as components having at least 3 methacrylate groups. In another example, the binder formulation includes not greater than about 30 wt. %, such as not greater than about 20 wt. %, not greater than about 10 wt. % or not greater than about 5 wt. % radically polymerizable compound.

The formulation may further include not greater than about 20 wt. % cationic photoinitiator, such as about 0.1 wt. % to about 20 wt. %, or not greater than about 20 wt. % radical photoinitiator, such as about 0.1 wt. % to about 20 wt. %. For example, the binder formulation may include not greater than about 10 wt. %, such as not greater than about 5 wt. % cationic photoinitiator. In another example, the binder formulation may include not greater than about 10 wt. %, such as not greater than about 5 wt. % free radical photoinitiator.

The particular filler includes dispersed submicron particulates. Generally, the binder formulation includes 5 wt. % to 80 wt. %, such as 5 wt. % to 60 wt. %, such as 5 wt. % to 50 wt. %, for example, 20 wt. % to 45 wt. % submicron particulate filler. Particular embodiments include at least about 5 wt. % particulate filler, for example at least about 10 wt. %, such as at least about 20 wt. %. In a particular embodiment, the particulate filler is solution formed silica particulate and may be colloidally dispersed in a polymer component. The exemplary binder formulation may further include not greater than about 5 wt. % dispersant, such as 0.1 wt. % to 5 wt. % dispersant, selected from organosiloxane, functionalised organosiloxane, alkyl-substituted pyrrolidone, polyoxyalkylene ether, and ethyleneoxide propylenenoxide block copolymer.

In a particular embodiment, the binder formulation is formed by mixing a nanocomposite epoxy or acrylate precursor, i.e., a precursor including submicron particulate filler. For example, the binder formulation may include not greater than about 90 wt. % nanocomposite epoxy and may include acrylic precursor, such as not greater than 50 wt. % acrylic precursors. In another example, a nanocomposite acrylic precursor may be mixed with epoxy.

The binder formulation including an external phase comprising polymeric or monomeric constituents and including dispersed particulate filler may be used to form a coating that is applied to a surface of the ophthalmic lens, it is exposed to radiation preferably in the ultraviolet range. Such radiation exposure causes the radically polymerizable polymer to rapidly cure creating a structure or lattice that retains the cationically polymerized polymer in place while it undergoes a slower photo curing process. As a result the cationically polymerized polymer cures in localized, encapsulated environments as it is retained by the quickly cured radically polymerizable polymer.

The coating system of the present disclosure is stable at room temperature and includes a reduced solvent concentration thereby reducing the overall VOC impact of the material. The coating system is formed as an epoxy/acrylate cationic hybrid coating that includes two polymerization initiators, one of which commences polymerization upon exposure to ultraviolet radiation, while the other is a photoinitiated catalyst. The coating may be further enhanced by the addition of colloidal nano-silica particles that serve to reinforce the mechanical properties of the coating system without compromising the overall transparency and optical clarity of the coating.

Further by employing a coating system such as described herein the epoxy/acrylate coating system is compatible with most dyes in a manner that allows the incorporation of infrared and near infrared energy filtering as well as the incorporation of other coating additives that serve to enhance the cleaning, anti-fogging and anti-reflective properties of the ophthalmic lens.

It is further preferred that the particular polymer substrate for the ophthalmic lens selected be well suited to the application in which the finished optical filter will be employed. For example, lens blanks are typically formed using a polycarbonate while windows are formed using acrylic. In practical application, the filter blank is formed for further use as lens blanks, lenses for eyewear, windows and filtering plates.

It can therefore be seen that the present disclosure provides a lens coating system that can be rapidly cured, offers the advantages of acrylate coatings yet has improved mechanical properties such as abrasion resistance. Further the present disclosure provides a coating system for application to a polymer ophthalmic lens that has improved abrasion resistance of the level of an epoxy coating, rapid curing of a radiation cured coating, while also being stable a room temperature, exhibiting low solvent/VOC content and supporting additives for features such as anti-fog, easy cleaning, anti reflection and targeted wavelength filtering. For these reasons, the instant disclosure is believed to represent a significant advancement in the art, which has substantial commercial merit.

### EXAMPLES

### Comparative Anti-Fog Performance Examples

### Prophetic

An UV curable epoxy/acrylate hybrid binder composition as illustrated in example 1.1, 1.2, and 1.3 respectively. Each coating is coated on the 76 mm polycarbonate lens blanks and followed by UV cure with combined Fusion D and H lamps at 50 ft/minute to give a dry thickness of 2 microns. Lens coating from each composition is exposed to the moisture generated from 80° C. hot water, and if a clear water film forms on the coating surface instead of fogging, it is considered as a good anti-fog coating. The composition with only nano silica will be used as reference to compare the effect of nano Al₂O₃ and TiO₂. The detailed compositions and anti-fog performance are summarized in the table below.

| | Exam- | Exam- | Exam- |
|---|---|---|---|
| Component | ple 1.1 | ple 1.2 | ple 1.3 |
| hydroxyethyl methacrylate (Aldrich) | 12 | 12 | 12 |
| poly(ethylene glycol) methacrylate | 6 | 6 | 6 |
| (PEGMA, average MW-500) | | | |
| (Aldrich) | | | |
| aliphatic urethane hexaacrylate | 6 | 6 | 3.5 |
| (cytec) | | | |
| dipentaerythritol pentaacrylate | 12 | 12 | 8 |
| (Sartomer SR-399 | | | |
| poly(ethylene glycol) monooleate | 3.5 | 3.5 | 3.5 |
| (Mn-860) (Aldrich) | | | |
| Irgacure 184 (BASF) | 2 | 2 | 2 |
| Chivacure 1176 (Chitec) | 5 | 5 | 5 |
| Achiwell 4221 (Brenntag Specialties, | 33.5 | 33.5 | 30 |
| Inc.) | | | |
| Nanopox.RTM. C 620 (nanoresins | 20 | 14 | 14 |
| AG 40% nanosilica in cycloaliphatic | | | |
| epoxy resin) | | | |
| NanoArc AL-2260 (40% | | 6 | 6 |
| nanoalumina in acrylate resin | | | |
| photo catalytic TiO2 X500 (TitanPE | | | 10 |
| Technologies, Inc., 50% in alcohol) | | | |
| total | 100 | 100 | 100 |
| abrasion resistance (Bayer ratio) | 3 | 3.5 | 3.5 |
| anti-fog performance in the | good | good | good |
| beginning | | | |
| anti-fog performance after 20 | fogging | good | good |
| windex wash | | | |
| anti-fog performance under UV | fogging | fogging | good |
| treatment and after 30 windex wash | | | |

Accordingly, coating compositions for transparent polymeric materials, methods for coating transparent polymeric materials, and coated transparent polymeric materials have been described. In an exemplary embodiment, an improved coating system for transparent polymeric materials, such as ophthalmic lenses, provides improved characteristics in the form of anti-fog performance and scratch and/or abrasion resistance, while also providing improved manufacturability and rapid curing as compared to prior art coating systems. Generally, the coating system is a composite coating that hybridizes both epoxy and acrylate coating materials into a single coating system with relatively low VOC content. In this manner, the coating system exhibits the mechanical properties imparted by epoxies creating a highly abrasion resistant coating while also including the advantageous properties of radiation cured coatings imparted by acrylates in the form of rapid processing and curing as well as a superior vehicle for carrying additives. The additives include a nano-sized particulate filler that is dispersed throughout the composite coating and comprises TiO₂ particles, and SiO₂ particles and/or Al₂O₃ particles. The composite coating is applied to a surface of the transparent polymeric material and is polymerized to form a coated transparent polymeric material. When moisture condenses onto the surface of the coated transparent polymeric material, the composite coating exhibits photo-induced hydrophilic and self-cleaning properties to impart long-lasting anti-fog performance to the transparent polymeric material.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

What is claimed is:

1. A hydrophilic and self cleaning UV nano-epoxy/acrylate cationic hybrid coating composition for a transparent polymeric material, the coating composition comprising:
a cationically polymerizable compound comprising at least one epoxy group;
a radically polymerizable compound comprising at least one (meth)acrylate group;
a surfactant with both hydrophilic and hydrophobic segments; and
a nano-sized particulate filler comprising TiO₂, and SiO₂ and/or Al₂O₃.

2. The coating composition of claim 1, wherein the surfactant comprises one or more reactive groups that can be chemically bonded to a polymer matrix by a curing process, and wherein the polymer matrix is formed of the cationically and radically polymerizable compounds.

3. The coating composition of claim 2, wherein the one or more reactive groups comprises vinyl, hydroxyl, carboxyl, acrylic, epoxy, urethane, amine, or a combination thereof, and wherein the curing process includes UV, thermal, moisture, or chemical crosslinking.

4. The coating composition of claim 1, wherein the surfactant comprises an ester, an ether, one or more ionic salts, or a combination thereof.

5. The coating composition of claim 1, wherein the nano-sized particulate filler comprises TiO₂ present in an amount of about 20 wt. % or less of the coating composition.

6. The coating composition of claim 1, wherein the nano-sized particulate filler comprises TiO₂ present in an amount of about 10 wt. % or less of the coating composition.

7. The coating composition of claim 1, wherein the nano-sized particulate filler comprises TiO₂ present in an amount of from about 1 to about 5 wt. % of the coating composition.

8. The coating composition of claim 1, wherein the nano-sized particulate filler comprises SiO₂ present in an amount of about 60 wt. % or less of the coating composition.

9. The coating composition of claim 1, wherein the nano-sized particulate filler comprises Al₂O₃ present in an amount of about 20 wt. % or less of the coating composition.

10. The coating composition of claim 1, wherein the nano-sized particulate filler comprises particles having an average particle size of about 100 nm or less.

11. The coating composition of claim 1, wherein the nano-sized particulate filler comprises colloidal TiO₂ particles, colloidal SiO₂ particles, colloidal Al₂O₃ particles, or mixtures thereof.

12. The coating composition of claim 1, wherein the nano-sized particulate filler is present in an amount of from about 5 to about 95 wt. % of the coating composition.

13. The coating composition of claim 1, wherein the cationically polymerizable compound and the radically polymerizable compound together form a polymerizable matrix that is present in an amount of from about 5 to about 95 wt.

14. The coating composition of claim 1, wherein a weight ratio of the cationically polymerizable compound to the radically polymerizable compound is from about 1:1 to about 2:1.

15. The coating composition of claim 1, further comprising a cationic polymerization initiator that causes polymerization of the cationically polymerizable compound upon exposure to ultraviolet radiation, thermal energy, or actinic radiation.

16. The coating composition of claim 1, further comprising a free radical polymerization initiator that causes polymerization of the radically polymerizable compound upon exposure to ultraviolet radiation, thermal energy, or actinic radiation.

17. A method for forming a coated transparent polymeric material, the method comprising the steps of:
preparing a coating composition, the coating composition comprising:
a cationically polymerizable compound comprising at least one epoxy group;
a radically polymerizable compound comprising at least one (meth)acrylate group;
a surfactant with both hydrophilic and hydrophobic segments; and
a nano-sized particulate filler comprising TiO₂, and SiO₂ and/or Al₂O₃;
applying the coating composition to a transparent polymeric material; and
polymerizing the cationically polymerizable compound and the radically polymerizable compound to form the coated transparent polymeric material.

18. The method of claim 17, wherein the step of preparing comprises combining a cationic polymerization initiator and a free radical polymerization initiator with the cationically polymerizable compound, the radically polymerizable compound, and the nano-sized particulate filler, and wherein the step of polymerizing comprises:
exposing the cationic polymerization initiator to ultraviolet radiation, thermal energy, or actinic radiation to cause polymerization of the cationically polymerizable compound; and
exposing the free radical polymerization initiator to the ultraviolet radiation, the thermal energy, or the actinic radiation to cause polymerization of the radically polymerizable compound.

19. A coated transparent polymeric material comprising:
a transparent polymeric material having a surface; and
a coating overlying the surface, the coating comprising:
a polymer matrix comprising a polymerized epoxy constituent and a polymerized (meth)acrylate constituent;
a surfactant with both hydrophilic and hydrophobic segments dispersed in the polymer matrix; and
a nano-sized particulate filler dispersed in the polymer matrix and comprising TiO₂, and SiO₂ and/or Al₂O₃.

20. The coated transparent polymeric material of claim 19, wherein the transparent polymeric material comprises a polymer selected from the group consisting of diethyleneglycol bisallyl carbonate, bisphenol A polycarbonate, and poly(methylmethacrylate).
